(19) United States
(12) Patent Application Publication
(10) Pub. No.: US 2025/0231283 A1
(43) Pub. Date: Jul. 17, 2025

(54) METHOD FOR EFFICIENT RADAR PRE-PROCESSING

(71) Applicant: INNATERA NANOSYSTEMS B.V., RIJSWIJK (NL)

(72) Inventors: Katarzyna Weronika KOZDON, RIJSWIJK (NL); Ayon BORTHAKUR, RIJSWIJK (NL); Petrut Antoniu BOGDAN, RIJSWIJK (NL); Dariusz MAKSIMIUK, RIJSWIJK (NL)

(21) Appl. No.: 18/853,741

(22) PCT Filed: Apr. 6, 2023
(86) PCT No.: PCT/EP2023/059218

§ 371 Date: Oct. 3, 2024

Related U.S. Application Data
(60) Provisional application No. 63/327,841, filed on Apr. 6, 2022.

(51) Int. Cl. G01S 7/41; G01S 13/32

(52) U.S. Cl. CPC G01S 7/41; G01S 13/32

(57) ABSTRACT

A system and method for pre-processing data for further processing by a machine learning model. The pre-processing comprises generating sample data from a transmitted signal and a received signal over a time period, allocating the sample data to a plurality of (L) range bins, selecting a first subset of (M) the range bins, generating evaluation data based on an evaluation of the sample data of the first subset of (M) the range bins against one or more criteria, selecting a second subset of (N) range bins based on the evaluation data, generating calculated data based on the sample data of the second subset of (N) range bins, and providing the evaluation data and the calculated data to a machine learning model with temporal dynamics for further processing.

### TECHNICAL FIELD

This disclosure generally relates to pre-processing of data for efficient automated target recognition. More specifically, but not exclusively, it relates to a system and method for pre-processing of received radar signals for object, person or gesture detection or recognition using a machine learning model with temporal dynamics.

### BACKGROUND

Radar uses radio waves to determine the distance (ranging), angle (azimuth and elevation), and radial velocity of objects relative to the radar system site. Radar is typically used to detect and track flying aircraft, spacecraft, missiles, etc. and to map weather formations and terrain. Recently small radar systems have also been used to detect object movements such a hand gestures for hands-free control of devices such as televisions.

A radar system consists of a transmitter producing electromagnetic waves in the radio or microwaves domain, a transmitting antenna, a receiving antenna (often the same antenna is used for transmitting and receiving) and a receiver and processor to determine properties of the objects. Radio waves (pulsed or continuous) from the transmitter reflect off the objects and return to the receiver, giving information about the objects' locations and speeds.

Automated target recognition using machine learning models have been used for gesture recognition for hands-free control of devices. In previously proposed systems, the pre-processing of data for input to such machine learning models has involved the generation of spectrograms of data derived from the received radar signals. Examples of spectrograms used for these applications include range-Doppler, micro-Doppler, range-angle and angle-Doppler. These spectrograms comprise a rectangular map of the relevant features against a time axis.

In case of range-Doppler, creation of a spectrogram requires computation of range profiles and Doppler (radial velocity) profiles to generate a range-Doppler surface comprising a large set of data representing variation in features such as range and velocity with time. This involves the storing and processing of a constant number of samples into a joint 2D representation of the selected features. This spectrogram-based approach requires a large computational and memory load which remains constant regardless of the input data, imposing a constant drain on the memory and power of the data pre-processing system. The same limitations also apply when extending from 2D to multi-dimensional representation, e.g. range-Doppler-angle.

### SUMMARY

To address the above discussed drawbacks of the prior art, the invention provides an “attention” mechanism which allows an intelligent adjustment of the data pre-processing parameters to focus on data of interest and conserve memory and power requirements.

The proposed innovation disentangles the features which would normally correspond to the axes of the spectrograms used in conventional systems. In the spectrogram approach, the selected features (such as detection, range, angle, velocity) are calculated for all sample data. In the proposed approach, each feature is calculated over a separate selection of sample data, calculating one feature for a first subset of samples, and another feature for a second set of samples. The selected samples can, but do not have to, be consecutive, which allows fine-tuning of range bin sampling resolution and processing cost per feature. Further, the number of the selected samples for a feature can be changed flexibly at any time point allowing a dynamic adjustment of the processing cost in response to the expected benefit at any given time.

In one aspect, a method is provided for pre-processing data for further processing by a machine learning model. The pre-processing comprises generating sample data from a transmitted signal and a received signal over a time period, allocating the sample data to a plurality of (L) range bins, selecting a first subset of (M) the range bins, generating evaluation data based on an evaluation of the sample data of the first subset of (M) the range bins against one or more criteria, selecting a second subset of (N) range bins based on the evaluation data, generating calculated data based on the sample data of the second subset of (N) range bins, and providing the evaluation data and the calculated data to a machine learning model with temporal dynamics for further processing.

The received signal may comprise signals received from a plurality of receive antennas, and sample data may be generated and pre-processed separately for each signal from each receive antenna. Generating sample data may comprise generating an intermediate frequency signal from the transmitted signal and the received signal over a time period, and applying a Fourier transform to the intermediate frequency signal. The intermediate frequency signal may be generated by mixing the transmitted signal and the received signal.

Each range bin may comprise sample data for a respective subrange of the frequency range of the transmitted signal. In this way, the range bins may include the sample data arranged in accordance with the range to which the sample data relates. The size and total number of (L) range bins may be predetermined or may be adjusted during operation of the system.

The data provided to the machine learning model may be limited to the evaluation data of the first subset of (M) range bins and the calculated data for the second subset of (N) range bins, but other data may also be provided to the machine learning model, such as the sample data of the first subset of (M) range bins and/or the second subset of (N) range bins, other data calculated or derived from the sample data of the first subset of (M) range bins and/or the second subset of (N) range bins.

The first subset of (M) range bins for the time period may be selected on the basis of sample data generated during a previous time period. In this way the selection of the first subset of (M) range bins may be dynamic, being a function of previous sample data and able to change each time period.

The criteria used to determine the second subset of (N) range bins may comprise whether the sample data of a respective range bin indicates an object of interest has been detected. The selection of the second subset of (N) range bins may thus be dynamic, being a function of the evaluation data and able to change each time period. Moreover, the selection of the second subset of (N) range bins may be made independently from the selection of the first subset of (M) range bins, since the selection of the second subset of (N) range bins is performed on the basis of different data than the selection of the first subset of (M) range bins.

The evaluation of sample data of the first subset of (M) range bins may comprise comparing a magnitude of the sample data of a range bin with a threshold, and the threshold may be adjusted based on a computed probability of false detection.

The calculated data may be angle of arrival data, which may be calculated on the basis of first sample data generated from a first received signal from a first receive antenna, and second sample data generated from a second received signal from a second receive antenna.

The transmitted signal and received signal may be radar signals, for example a frequency modulated continuous wave radar signal, and the time period may be determined based on the period of a chirp of the transmitted signal.

The method may further comprise repeating the pre-processing for a series of consecutive time periods to provide a series of evaluation data and calculated data associated with the series of consecutive time periods to the machine learning model for further processing. The machine learning model may be adapted to perform object, person or gesture detection or recognition based on the provided sample data and calculated data for a sequence of time periods.

In another aspect, a system is provided for pre-processing data for further processing by a machine learning model with temporal dynamics. The system comprises a input circuit for receiving a transmitted signal and a received signal, a processor which is configured to generate sample data from a transmitted signal and a received signal over a time period, allocate the sample data to a plurality of (L) range bins, select a first subset of (M) the range bins, generate evaluation data based on an evaluation of the sample data of the first subset of (M) the range bins against one or more criteria, select a second subset of (N) range bins based on the evaluation data, and generate calculated data based on the sample data of the second subset of (N) range bins. The system also includes an output circuit adapted to provide the evaluation data and the calculated data to a machine learning model with temporal dynamics for further processing.

The processor may comprise a microprocessor, ASIC, FPGA, or combination of these and other circuits. The system may also comprise a memory, which may be implemented as a block of memory or as distributed memory elements. The system may further comprise a sensor comprising one or more transmit antennas and one or more receive antennas, the sensor generating the receive signal from the one or more receive antennas. The system may further comprise a machine learning model. The system including the sensor and machine learning model may be integrated in a single semiconductor chip.

The processor may be configured to select the first subset of (M) range bins on the basis of sample data generated during a previous time period. The processor may be configured to select the second subset of (N) range bins on the basis of whether the sample data of a respective range bin indicates an object of interest has been detected. The evaluation of sample data of the first subset of (M) range bins may comprise comparing a magnitude of the sample data of a range bin with a threshold, and the processor may be configured to adjust the threshold based on a computed probability of false detection.

The processor may be configured to repeatedly generate the evaluation data and the calculated data for a series of consecutive time periods to provide a series of evaluation data and calculated data associated with the series of consecutive time periods to the machine learning model for further processing.

### BRIEF DESCRIPTION OF DRAWINGS

Embodiments will now be described, by way of example only, with reference to the accompanying schematic drawings in which corresponding reference symbols indicate corresponding parts, and in which:

FIG. 1 is a schematic diagram of a radar system which may be used with the invention;

FIGS. 2a-2c are schematic diagrams showing data of a first subset of M range bins generated for each time period over a period of time;

FIG. 3 is a flow diagram showing an example of data pre-processing for a system such as the one shown in FIG. 1; and

FIG. 4 is a schematic diagram showing data of a first subset of M range bins and data of a second subset of N range bins generated for each time period over a period of time.

The figures are intended for illustrative purposes only, and do not serve as restriction of the scope or the protection as laid down by the claims.

### DESCRIPTION OF EMBODIMENTS

Hereinafter, certain embodiments will be described in further detail. It should be appreciated, however, that these embodiments may not be construed as limiting the scope of protection for the present disclosure.

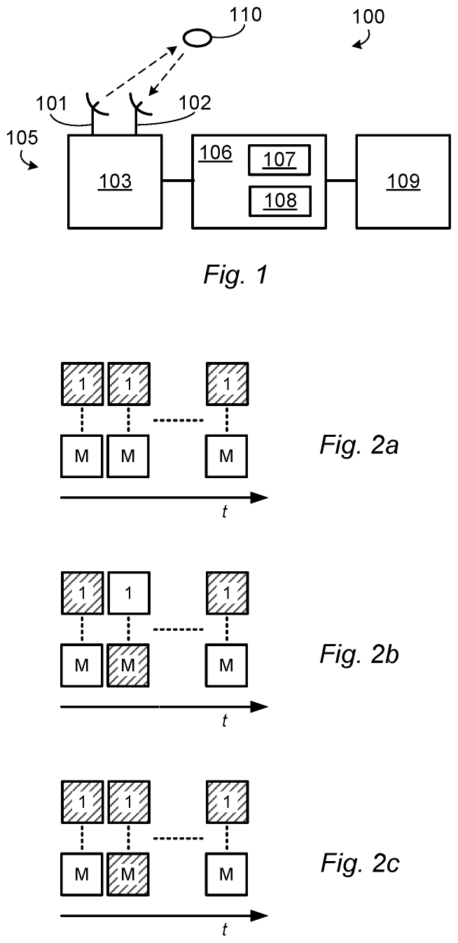

FIG. 1 is a schematic diagram of a radar system 100 comprising one or more transmit antennas 101 and one or more receive antennas 102 coupled to transmit and receive circuitry 103 and together forming a sensor 105. The system transmits radio waves known as radar signals in predetermined directions. When an object 110 is present in detection range of the system, the transmitted signals are usually reflected or scattered by the object, and a portion of the signals will be received by the receive antennas 102. The received signals may be processed to obtain range (distance to the object), angle (azimuth and elevation), radial velocity (Doppler).

The system 100 of FIG. 1 includes a data pre-processing system 106 including memory 107 for storing signal data and processed data, and a processor 108 for performing the data pre-processing. The data pre-processing system 106 provides the pre-processed data to a machine learning model 109 for further processing, for inferring the object's characteristics such as its location, displacement, velocity, count, material, shape and category it belongs to from the received signals, and may also be configured for inferring the type of gesture being performed.

The data pre-processing system 106 and the machine learning model 109 may be implemented in hardware circuitry, in software, or a combination of hardware circuitry and software, for example implemented using a microprocessor, ASIC, FPGA, or combination of these and other circuits. The processor 108 may similarly be implemented in a variety of different ways using a microprocessor, ASIC, FPGA, or combination of these and other circuits. The memory 107 may be implemented as a block of memory or as distributed memory elements.

The data pre-processing system 106 and the machine learning model 109 may be implemented as separate units (e.g. in separate integrated circuits) or as one integral unit (e.g. both implemented by integrated circuits in one semiconductor chip). The complete system may be implemented with the sensor 105 (including transmit and receive antennas 101, 102), the data pre-processing system 106, and the machine learning model 109, all integrated in a single semiconductor chip.

Different types of radar signals may be used, for example pulsed or continuous wave radar signals, which are frequency modulated or not. Various types of frequency modulation of the signal may be used, for example with signal frequency varying in a sawtooth, triangular or segmented linear waveform. Embodiments of the invention are described in the context of a continuous wave radar signal, but the invention is equally applicable to other types of systems and other type signals.

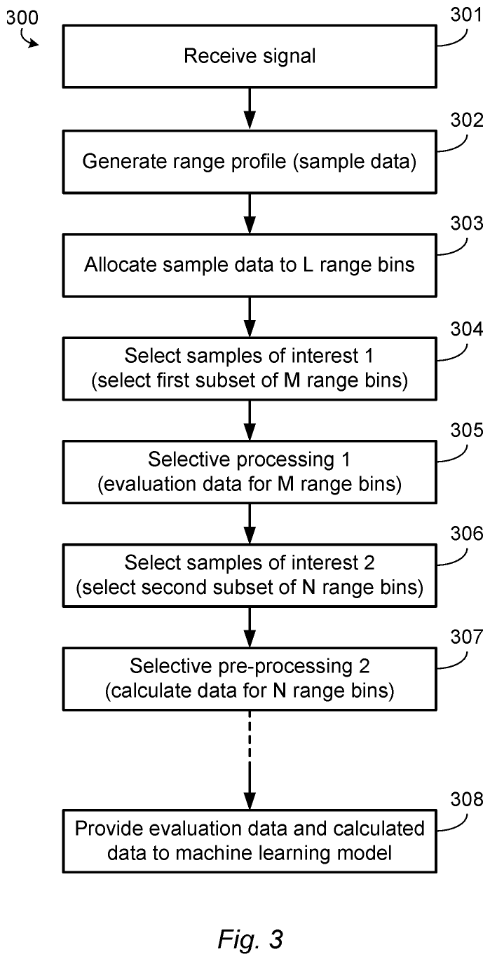

FIG. 3 is a flow diagram showing an example of data pre-processing for a system such the one shown in FIG. 1.

In step 301 a signal is received for data pre-processing. For a radar system, the received signal is essentially an attenuated and delayed version of the transmitted signal. A received signal is preferably generated from each of two or more receive antennas to facilitate calculation of angle of arrival of the received signal. The radar system comprises one or more transmit antennas and one or more receive antennas, and preferably comprises three or more receive antennas with a pair of receive antennas separated in an x-axis direction a pair of receive antennas separated in a y-axis direction. The signal received from each receive antenna is preferably processed in a separate channel.

### Generating Range Profile

In step 302, a range profile is generated from the transmitted and received signals over a time certain period. The received signal from a first one of the antennas is initially processed in a first channel to obtain data suitable for further processing. For example, an intermediate frequency (IF) signal is typically derived representing a difference between the transmitted and received signals. This signal may be generated by mixing (e.g. multiplying) the transmitted and received signals, and various known pre-processing steps may be performed, such as noise reduction, filtering and/or scaling of the signals if required, and conversion of the signal from analog to digital form.

The IF signal data is divided into time periods for generating the range profile. For example, the time period may be the period of one “chirp” of a frequency modulated continuous wave (FMCW) radar during which the frequency of the transmitted signal is swept through its frequency range. One chirp of a FMCW radar corresponds with the time period during which the frequency of the transmitted signal is varied over its frequency range, for example the period of sweeping the frequency from a lowest frequency to a highest frequency for a frequency modulation following a sawtooth function. When the transmitted signal is not frequency modulated, the time period may be determined based on a suitable time window for the transmitted signal. The range profile represents received signal data spanning from the shortest range (lowest frequency of the IF signal) to the longest range (highest frequency of the IF signal).

The range profile comprises sample data generated from the IF signal and allocated to range bins. The frequency of the IF signal is a function of range (e.g. distance between the radar system and a detected object which reflects the transmitted signal), although its frequency may also vary to some extent in dependence on other factors such as velocity of a detected object and variation in the density of the medium through which the signal passes.

Sample data may be calculated from the IF signal for each time period, for example by applying a Fourier transform to the IF signal over a time period, to generate a range profile comprising sample values representing the IF signal amplitude at different ranges for the time period. A Fast Fourier Transform (FFT) or Discrete Fourier Transform (DFT) algorithm may be used, or other algorithms may be used to generate the range profiles such as a Goertzel or Multiple Signal Classification (MUSIC) algorithm. The generated sample data may take the form of a real, imaginary or complex number.

The time period used for calculating the sample data may be selected as the period of each chirp in a frequency modulated radar or for a suitable time window in a radar without frequency modulation. The sample data for each time period forms a range profile. The sample data may undergo pre-processing, for example by applying a moving target indication (MTI) technique to the data to remove or reduce sample data associated with static objects.

### Allocating the Sample Data to Range Bins

In step 303, the sample data is allocated to a plurality of (L) range bins. The transmitted and received signals vary within a certain frequency range, which may be subdivided into a number of frequency subranges forming range bins, each range bin comprising sample data for a respective frequency subrange. The sample data of each range profile is allocated to a number of (L) range bins, each range bin comprising sample data for a respective frequency subrange. The size and total number of (L) range bins may be predetermined or may be adjusted during operation of the system.

The received signal from a second receive antenna may also be processed in parallel in a second channel as described above, including generating a second IF signal, generating second sample data from the second IF signal, and allocating the second sample data to second range bins. Similarly, the received signal from any further receive antennas may also be processed in parallel in further channels in a similar way, to result in sample data allocated to range bins for each such receive antenna. Thus, for a system comprising three receive antennas, sample data is generated and allocated to corresponding range bins for the three received signals from the three receive antennas.

### Selecting a First Subset of Sample Data of Interest

In step 304, a first subset of (M) the range bins is selected. The size, number and position of the first subset of range bins may be predetermined or may be adjusted dynamically during operation of the system. The first subset of range bins may be updated each time period, e.g. for each chirp in a frequency modulated radar or for each time window in a radar without frequency modulation. The first subset of (M) range bins may include all of the (L) range bins (M=L) or a selection of less than all of the range bins (M<L). The selected range bins may be consecutive (adjacent) range bins or be non-consecutive covering disparate parts of the detection range of the system.

FIG. 2a is a schematic diagram showing a first subset of range bins numbered 1 to M, the range bins generated for each time period to form a sequence of subsets of M range bins, each range bin with associated sample data.

This step operates as a first selection of data of interest, so that subsequent processing of the data is focused in an intelligent way on data which is especially useful for the relevant application, e.g. object or gesture recognition. The selection of range bins may be based on the range profile (sample data) of a previous time period, or the sample data processed earlier within the range profile of the current time period, or other data which provides an indication that the selected range bins in the current time period include sample data of interest. The selection of data is thus dynamic, being a function of the actual data and able to change each time period.

The selection may be done, for example, to reduce the number of range bins to be further processed if no object was detected in the previous time period, or to increase the number of range bins if an object was detected in a previous time period. It may also select only range bins pertaining to certain ranges if an object was detected within those ranges in a previous time period. If an object was detected within a certain range in a previous time period (e.g. in the immediately preceding time period or in multiple previous time periods) then detection of the object is more likely to occur in the same or similar range in the current time period.

The selection of range bins may thus focus the processing resources expended by the system on the ranges of interest, while reducing the total processing resources consumed and thus saving power.

### Selective Pre-Processing (Generating Evaluation Data)

In step 305, selective pre-processing of the first subset of (M) range bins is performed. This may comprise generating evaluation data based on an evaluation of the sample data of the first subset of (M) the range bins against one or more criteria. The criteria used for this evaluation may be based on any one or more features of the sample data, for example range (distance from radar system to detected object), angle (azimuth and/or elevation between radar system and detected object), detection (whether an object is detected within the range encompassed by the range bin), radial velocity (velocity of detected objects to/from the radar system), rate of change of one of these features or other value derived from one of these features. The evaluation may also include multiple rounds of testing against multiple criteria.

For example, the selection may be based on whether the sample data in a range bin indicates that an object of interest has been detected within the range covered by the range bin (i.e. where the relevant feature is “detection”). This may be implemented based on a detection threshold, where the magnitude of the sample data in each range bin is compared with a detection threshold. In this example, the criteria for selection may be whether the magnitude of the signal data in a range bin exceeds the detection threshold, in which case that range bin is selected for the selective pre-processing.

FIGS. 2a-2c are schematic diagrams showing a first subset of range bins numbered 1 to M generated for each time period over a period of time. FIG. 2a shows the situation in which the first range bin (bin 1) in each time period satisfies the relevant criteria, for example an object was detected within the range represented by the first range bin. FIG. 2b shows the situation in which the first range bin (bin 1) in the first time period satisfies the relevant criteria and the last range bin (bin M) in the second time period satisfy the relevant criteria. FIG. 2c shows the situation in which the first range bin (bin 1) in the first time period and both the first and last range bins (bin 1 and bin M) in the second time period satisfy the relevant criteria.

The criteria for use in the evaluation process may be predefined and static, for example using a static threshold which is determined experimentally, e.g. by hyperparameter grid search involving choosing threshold values and evaluating the results. Alternatively, the criteria may be dynamic, for example using an adaptive threshold which is adjusted for each time period based on a computed probability of false detection, using methods such as Constant False Alarm Rate (CFAR), Cell-Averaging CFAR, Ordered-Statistic CFAR, or other methods.

The selective pre-processing and generation of the evaluation data is performed only for the data of interest, i.e. only on the first subset of (M) range bins, and not for the other range bins which were not selected for the first subset. The selective pre-processing generates evaluation data for use by the machine learning model focused on the data of interest. In addition, the evaluation data is used for a further selection of data of interest to enable a yet further reduction in the required data processing. In this way, the amount of pre-processing is further reduced to focus the processing resources expended by the system on the data of interest to reduce the processing resources consumed and save power.

### Selecting Data for Further Selective Pre-Processing

In step 306, a further selection of data of interest is made. A second subset of (N) range bins is selected based on the evaluation data generated for the first subset of (M) range bins. This selection process may result in selecting all range bins which meet the criteria, or selecting a certain number of range bins which meet the criteria (e.g. selecting the first three range bins which meet the first selection criteria), or applying another selection method to the first set of range bins based on the evaluation data.

For example, if the evaluation data indicates whether an object of interest has been detected for each range bin of the first subset of range bins, the selection process may comprise selecting all of the range bins for which an object was detected, or selecting the first three range bins (having the lowest range values) for which an object was detected, or selecting the three range bins which have the highest signal magnitudes among the range bins for which an object was detected, or applying some other suitable selection rule.

The number of range bins in the second subset of (N) range bins may vary between zero, indicating that none of the range bins include data of interest and no range bins are selected, and M, indicating that all of the range bins of the first subset of range bins include data of interest and all of the range bins selected. However, the criteria used for the selection preferably results in fewer range bins being selected to conserve processing resources.

This step operates as a second selection of data of interest, so that subsequent processing of the data is further focused in an intelligent way on data which is especially useful for the relevant application. The second selection of data is also dynamic, being a function of the sample data and able to change each time period. The first and second selections of data of interest (steps 304 and 306) may be adjusted independently, the first selection being based on the range profile (sample data) of a previous time period, while the second selection is based on the evaluation data derived from the sample data selected by the first selection.

### Selective Pre-Processing (Generating Calculated Data)

In step 307, selective pre-processing of the second subset of (N) range bins is then performed. The selective pre-processing may comprise, for example, generating calculated data from the sample data of the second subset of range bins for input to a machine learning model. This selection of sample data/range bins is made in order to focus on the data of interest, i.e. the data which is most useful in the subsequent data processing by the machine learning model for the relevant application, e.g. object or gesture detection or recognition.

For example, the selective pre-processing may comprise calculating angle of arrival data for the data samples in the second subset of (N) range bins selected by the selection process. Angle of arrival data may be calculated from the sample data in each range bin, for example by calculating a phase difference between the signal received at two receiver antennas.

The second selective pre-processing and generation of the calculated data is performed only for the further data of interest, i.e. only on the second subset of (N) range bins, and not for the other range bins which were not selected for the second subset. The selective pre-processing thus generates calculated data for use by the machine learning model focused on the further data of interest. This again reduces the amount of pre-processing to focus the processing resources expended by the system and save power.

The first and second selections of data of interest (steps 304 and 306) and the first and second selective pre-processing (steps 305 and 307) may be adjusted independently, since the first and second selections, which determine the first and second subsets of range bins, are based on different data.

The dimensionality of each feature can be adjusted independently. This means that when a feature is used as the basis for selection of range bins, the number of range bins and thus the size of the data set provided as input for further processing (e.g. as input to the machine learning model) will vary in dependence on the adjustment of the criteria (e.g. threshold) relating to that feature. Where more than one feature is used for selection of range bins, the criteria relating to each feature may be adjusted independently.

This adjustment of the criteria relating to a feature can be a function of a current or previous value of a feature, or a function of a different feature, or a function of a current or previous value of a combination of features.

For example, when the selection process is based on the object detection feature using a detection threshold, the appearance or disappearance of objects within the detection range of a radar signal may result in a change in the number of selected range bins. When an object appears within the detection range, the number of range bins with sample data having a magnitude above the detection threshold increases, and the number of selected range bins may correspondingly increase. Conversely, when an object disappears from the detection range, the number of range bins selected by the data selection process may correspondingly reduce.

Similarly, when the selection feature is range or angle of interest, the presence of one or more objects within the range or angle of interest may result in a change in the number of selected range bins.

When the number of range bins selected by the data selection process changes, then the number of data samples which undergo data pre-processing also changes in the same way.

The number of samples for which Angle of Arrival was calculated was dynamically optimized; if fewer than N samples had magnitude values above the detection threshold, the same lower than N count of samples was used for Angle of Arrival calculation. Therefore, the number of samples was subject to a dynamic change between 0 and N.

### Additional Data Selection and Selective Pre-Processing

The flowchart in FIG. 3 illustrates an example having two selections of data samples (producing two subsets of range bins) and two selective pre-processing steps. However, additional data selections and selective pre-processing may be performed. The additional data selections may be made on the basis of different features than those used for the first two data selections, and the additional selective pre-processing may involve different processing and/or calculating different values than the first two selective pre-processing steps.

### Output the Evaluation Data and Calculated Data

In step 309, the system provides the pre-processed data comprising the evaluation data associated with the first subset of (M) range bins and the calculated data associated with the second subset of (N) range bins for input to a machine learning model with temporal dynamics. For example, the evaluation data may comprise detection data indicating whether an object is detected within the range encompassed each range bin of the first subset of (M) range bins, and the calculated data may comprise angle of arrival data for each range bin of the second subset of (N) range bins. If additional data selections and selective pre-processing steps are included, the resulting evaluation data and/or calculated data from these additional steps may also be provided to the machine learning model.

The system repeatedly performs the data pre-processing steps of FIG. 3 to generate a set of evaluation data and calculated data for each time period of a sequence of time periods. The resulting sets of sample data and calculated data are provided to the machine learning model sequentially for further processing.

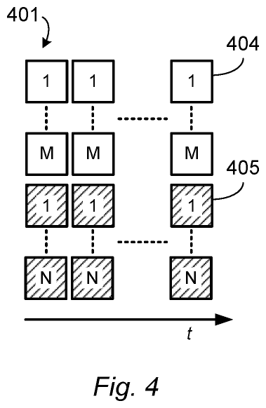

FIG. 4 is a schematic diagram showing the evaluation data 404 of a first subset of M range bins and the calculated data 405 of a second subset of N range bins generated for each time period over a period of time t. The evaluation data 404 and the calculated data 405 may provided to the machine learning model 109 as is or may be encoded for processing by the machine learning model.

For example, for evaluation data comprising detection, the sample data may be processed to remove static detections (e.g. using a moving target indication technique to discriminate a moving target against clutter) and binarize the magnitude of the processed sample data to determine a detection/no-detection value. For calculated data comprising angle of arrival, the calculated data may be quantized, for example azimuth angle data may be quantized as left-middle-right and elevation angle data may be quantized as top-middle-bottom.

The machine learning model is configured for modelling temporal data which changes dynamically. For example, a Spiking Neural Network (SNN), Recurrent Neural Network (RNN) or Long Short-Term Memory (LSTM) network may be used.

The embodiments are described in the context of a system for object, person or gesture detection or recognition, although the invention may also be applied to applications which benefit from the described type of pre-processing of data for input to a machine learning model.

The embodiments are described in the context of radar signals, although the invention may also be applied to other types of signals which generate data for input to a machine learning model and would benefit from the described data pre-processing.

While certain embodiments of the invention have been described herein, the invention is not limited to these embodiments. Two or more of the above embodiments may be combined in any appropriate manner, an elements and components of the described embodiments may be substituted or modified using alternatives readily apparent to the skilled person.

1. A method for pre-processing data for further processing by a machine learning model, the method comprising:
generating sample data from a transmitted signal and a received signal over a time period;
allocating the sample data to a plurality of (L) range bins;
selecting a first subset of (M) the range bins;
generating evaluation data based on an evaluation of the sample data of the first subset of (M) the range bins against one or more criteria;
selecting a second subset of (N) range bins based on the evaluation data;
generating calculated data based on the sample data of the second subset of (N) range bins; and
providing the evaluation data and the calculated data to a machine learning model with temporal dynamics for further processing.

2. The method of claim 1, wherein the first subset of (M) range bins for the time period is selected on the basis of sample data generated during a previous time period.

3. The method of claim 1 or claim 2, wherein the criteria used to determine the second subset of (N) range bins comprises whether the sample data of a respective range bin indicates an object of interest has been detected.

4. The method of any one of the preceding claims, wherein the evaluation of sample data of the first subset of (M) range bins comprises comparing a magnitude of the sample data of a range bin with a threshold.

5. The method of claim 4, wherein the threshold is adjusted based on a computed probability of false detection.

6. The method of any one of the preceding claims, wherein the calculated data is angle of arrival data.

7. The method of claim 6, wherein the angle of arrival data is calculated on the basis of first sample data generated from a first received signal from a first receive antenna, and second sample data generated from a second received signal from a second receive antenna.

8. The method of any one of the preceding claims, further comprising repeating the pre-processing steps of claim 1 for a series of consecutive time periods to provide a series of evaluation data and calculated data associated with the series of consecutive time periods to the machine learning model for further processing.

9. The method of any one of the preceding claims, wherein the transmitted signal and received signal are radar signals.

10. The method of any one of the preceding claims, wherein the transmitted signal is a frequency modulated continuous wave radar signal, and the time period is determined based on the period of a chirp of the transmitted signal.

11. The method of any one of the preceding claims, wherein the machine learning model is adapted to perform object or gesture detection or recognition based on the provided sample data and calculated data for a sequence of time periods.

12. A system (100) for pre-processing data for further processing by a machine learning model with temporal dynamics (109), the system being arranged to receive a transmitted signal and a received signal, and the system comprising a processor (108) configured to:
generate sample data from a transmitted signal and a received signal over a time period;
allocate the sample data to a plurality of (L) range bins;
select a first subset of (M) the range bins;
generate evaluation data based on an evaluation of the sample data of the first subset of (M) the range bins against one or more criteria;
select a second subset of (N) range bins based on the evaluation data; and
generate calculated data based on the sample data of the second subset of (N) range bins; and
the system being configured to provide the evaluation data and the calculated data to a machine learning model with temporal dynamics for further processing.

13. The system (100) of claim 12, wherein the processor (108) is configured to select the first subset of (M) range bins on the basis of sample data generated during a previous time period.

14. The system (100) of claim 12 or claim 13, wherein the processor (108) is configured to select the second subset of (N) range bins based on whether the sample data of a respective range bin indicates an object of interest has been detected.

15. The system (100) of any one of claims 12-14, wherein the processor (108) is configured to repeatedly generate the evaluation data and the calculated data for a series of consecutive time periods to provide a series of evaluation data and calculated data associated with the series of consecutive time periods to the machine learning model for further processing.

16. The system (100) of any one of claims 12-15, further comprising a sensor (105) including one or more transmit antennas (101) and one or more receive antennas (102), and a machine learning model (109), integrated in a single semiconductor chip.
